(19) United States
(12) Patent Application Publication
(10) Pub. No.: US 2026/0187854 A1
(43) Pub. Date: Jul. 2, 2026

(54) CONTROL METHOD AND COMPONENT FOR PICTURE DISPLAY OF AR GLASSES

(71) Applicant: GOERTEK TECHNOLOGY CO., LTD, Qingdao, Shandong (CN)

(72) Inventors: Gaojian SHI, Qingdao, Shandong (CN); Chao ZHANG, Qingdao, Shandong (CN)

(21) Appl. No.: 18/858,460

(22) PCT Filed: Aug. 31, 2023
(86) PCT No.: PCT/CN2023/116257

§ 371 Date: Oct. 21, 2024

(30) Foreign Application Priority Data
Sep. 6, 2022 (CN) 202211083940.2

(51) Int. Cl. G06T 11/00; G06F 3/14

(52) U.S. Cl. CPC G06T 11/00; G06F 3/14; G06T 2210/21

(57) ABSTRACT

Disclosed are a control method and component for picture display of AR glasses. The method includes: assigning a corresponding angle-of-view range to a preconfigured rendering device; acquiring current pose data of the AR glasses; according to the current pose data, determining whether the angle-of-view range meets a preset condition; if the angle-of-view range meets the preset condition, sending a rendering instruction to a first target rendering device, the angle-of-view range of which meets the preset condition, such that the first target rendering device renders the current picture to obtain a target display picture; and after all the target display pictures are acquired, displaying the target display pictures in a fusion manner. The situation of picture lagging or it not being possible to complete rendering due to insufficient computing power when the AR glasses complete rendering by themselves is avoided, thereby improving the picture rendering capability and improving the user experience.

This application claims priority to a Chinese patent application No. 202211083940.2, entitled “CONTROL METHOD AND COMPONENT FOR PICTURE DISPLAY OF AR GLASSES”, filed with the China Patent Office on Sep. 6, 2022, the entire contents of which are incorporated by reference in this application.

### TECHNICAL FIELD

The present application relates to the technical field of intelligent wearable devices, and in particular, to a control method and component for picture display of AR glasses.

### BACKGROUND

Augmented Reality (AR) is a technology that cleverly integrates virtual information with the real world. AR technology is widely used in various aspects of life, such as transportation, medical care, family and education. For example, when doing interior design such as house decoration, AR technology can be used to present the final renderings in advance through AR devices before the renovation.

In recent years, with the rapid development of AR technology, AR glasses have evolved from bulky all-in-one devices to compact devices with the size and appearance of myopic glasses. As AR glasses become lighter and smaller, the memory size and CPU computing power used in AR glasses will be affected to a certain extent, resulting in lags in the rendering and presentation of some complex scenes, or even failure to display, which in turn brings a bad experience to users.

It can be seen that how to solve the problem of AR glasses devices being unable to render and present complex scenes and improve user experience is an urgent problem to be solved by those skilled in the art.

### SUMMARY

The purpose of this application is to provide a control method and component for picture display of AR glasses, so as to avoid the inability to render complex scenes when the AR glasses themselves have insufficient computing power, thereby improving the user experience.

In order to solve the above technical problem, the present application provides a method for controlling picture display of AR glasses, including:
assigning a corresponding angle-of-view range to each of preconfigured rendering devices;
acquiring current pose data of the AR glasses;
determining, according to the current pose data, whether the angle-of-view range meets a preset condition;
if the angle-of-view range meets the preset condition, sending a rendering instruction to a first target rendering device, the angle-of-view range of which meets the preset condition, such that the first target rendering device renders the current picture to obtain a target display picture; and
after all the target display pictures are acquired, displaying the target display pictures in a fusion manner.

Preferably, the determining, according to the current pose data, whether the angle-of-view range meets a preset condition includes:

determining whether there is an intersection between the angle-of-view range and the field of view of the AR glasses according to the current pose data.

Preferably, the method for controlling picture display of AR glasses further includes:
if it is determined that there is no intersection between the field of view and the angle-of-view range, sending a sleep instruction to the first target rendering device, and returning to the acquiring the current pose data of the AR glasses themselves.

Preferably, rendering the current picture includes:
determining a percentage of the intersection between the field of view and the angle-of-view range against the angle-of-view range;
determining a ratio of rendering the current picture according to the percentage; and
rendering the current picture according to the ratio.

Preferably, the method further includes: before the displaying the target display pictures in a fusion manner,
determining whether each of the target display pictures meets a display condition; wherein the display condition at least includes that resolution reaches a preset value, and that a target number of the target display pictures are acquired;
if the display condition is met, proceeding to the displaying the target display pictures in a fusion manner;
if the display condition is not met, reassigning the angle-of-view range to the rendering devices, and proceeding to the acquiring the current pose data of the AR glasses themselves.

Preferably, the method for controlling picture display of AR glasses further includes:
when a target trigger instruction is received, reassigning a corresponding angle-of-view range to a second target rendering device; wherein the target trigger instruction is an instruction generated when any one of the rendering devices is disconnected and/or the rendering task is terminated and/or the battery is low, and the second target rendering device is a device that has not triggered the target trigger instruction.

Preferably, the assigning a corresponding angle-of-view range to each of preconfigured rendering devices includes:
acquiring performance parameters and current application scenarios of each of the rendering devices; wherein the performance parameters at least include memory size and computing power;
selecting a target number of rendering devices according to the current application scenario; and
sorting the target number of rendering devices based on performances, and assigning angle-of-view ranges from large to small to corresponding rendering devices according to the performances from high to low.

In order to solve the above technical problem, the present application also provides a device for controlling picture display of AR glasses, including:
an assigning module configured to assign a corresponding angle-of-view range to each of preconfigured rendering devices;
an acquisition module configured to acquire current pose data of the AR glasses themselves;
a determining module configured to determine whether the angle-of-view range meets a preset condition according to the current pose data, and if so, call a sending module;
the sending module configured to send a rendering instruction to a first target rendering device, the angle-of-view range of which meets the preset condition, such that the first target rendering device renders the current picture to obtain a target display picture; and
a fusion module configured to, after all the target display pictures are acquired, display the target display pictures in a fusion manner.

In order to solve the above technical problem, the present application also provides AR glasses including:
a memory on which a computer program is stored; and
a processor configured to implement steps of the method for controlling picture display of AR glasses as described above when executing the computer program.

In order to solve the above technical problem, the present application also provides a computer-readable storage medium, wherein a computer program is stored on the computer-readable storage medium, and when the computer program is executed by a processor, steps of the method for controlling picture display of AR glasses as described above are implemented.

The present application provides a method for controlling picture display of AR glasses, including: assigning a corresponding angle-of-view range to a preconfigured rendering device; acquiring the current pose data of the AR glasses themselves; determining, according to the current pose data, whether the angle-of-view range meets a preset condition; if the angle-of-view range meets the preset condition, sending a rendering instruction to a first target rendering device, the angle-of-view range of which meets the preset condition, such that the first target rendering device renders the current picture to obtain a target display picture; and after all the target display pictures are acquired, displaying the target display pictures in a fusion manner. Thus, according to the technical solution of the present application, when the angle-of-view range corresponding to the preconfigured rendering device meets the preset condition, the rendering device completes a picture rendering job of AR glasses, and after all target display pictures rendered by a first target rendering device are obtained, the target display pictures are displayed in a fusion manner, such that the situation of picture lagging or it not being possible to complete rendering due to insufficient computing power when the AR glasses complete rendering by themselves is avoided, thereby improving the picture rendering capability and improving the user experience.

In addition, the present application also provides a device for controlling picture display of AR glasses, AR glasses and a medium, which correspond to the above-mentioned method for controlling picture display of AR glasses and have the same effect as above.

### BRIEF DESCRIPTION OF DRAWINGS

In order to more clearly illustrate the embodiments of the present application, the following is a brief introduction to the drawings required for use in the embodiments. Obviously, the drawings described below are only some embodiments of the present application. For those skilled in the art, other drawings can be obtained based on these drawings without paying any creative work.

FIG. 1 is a flow chart of a method for controlling picture display of AR glasses provided in an embodiment of the present application;

FIG. 2 is a schematic diagram of an angle-of-view range provided in an embodiment of the present application;

FIG. 3 is a schematic diagram of an AR glasses picture rendering provided in an embodiment of the present application;

FIG. 4 is a structural diagram of a device for controlling picture display of AR glasses provided in an embodiment of the present application;

FIG. 5 is a structural diagram of AR glasses provided in another embodiment of the present application.

### DETAILED DESCRIPTIONS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by those skilled in the art without creative work are within the scope of protection of this application.

It should be noted that all directional indications (such as up, down, left, right, front, back . . . ) in the embodiments of the present application are only used to explain the relative position relationship, movement status, etc. between the components under a certain specific posture (as shown in the accompanying drawings). If the specific posture changes, the directional indication will also change accordingly.

In this application, unless otherwise clearly specified and limited, the terms “connection”, “fixation”, etc. should be understood in a broad sense. For example, “fixation” can be a fixed connection, a detachable connection, or an integral connection; it can be a mechanical connection or an electrical connection; it can be a direct connection or an indirect connection through an intermediate medium, it can be the internal connection of two elements or the interaction relationship between two elements, unless otherwise clearly defined. For those skilled in the art, the specific meanings of the above terms in this application can be understood according to specific circumstances.

In addition, in this application, descriptions such as “first”, “second”, etc. are only used for descriptive purposes and cannot be understood as indicating or implying their relative importance or implicitly indicating the number of technical features indicated. Therefore, the features defined as “first” and “second” may explicitly or implicitly include at least one of the features. In addition, the technical solutions between the various embodiments can be combined with each other, but they must be based on the ability of those skilled in the art to implement them. When the combination of technical solutions is contradictory or cannot be implemented, it should be deemed that such combination of technical solutions does not exist and is not within the scope of protection required by this application.

The following description will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by those skilled in the art without creative work are within the scope of protection of this application.

The core of this application is to provide a control method and component for picture display of AR glasses, which assign an angle-of-view range to a preconfigured rendering device, send a rendering instruction to a rendering device when the angle-of-view range meets a preset condition, the rendering device completes a picture rendering job of AR glasses, and after all target display pictures rendered by the rendering devices are acquired, display the target display pictures in a fusion manner, so as to overcome the problem that AR glasses cannot render complex scenes due to insufficient computing power.

In order to enable those skilled in the art to better understand the present application, the present application is further described in detail below in conjunction with the accompanying drawings and specific implementations.

With the continuous development of science and technology and the increasing demand for quality of life, AR technology is widely used in various aspects of life such as transportation, medical care, family and education. For example, when doing interior design such as house decoration, AR technology can be used to present the final renderings in advance through AR devices before the renovation.

In recent years, with the rapid development of AR technology, AR glasses have evolved from bulky all-in-one devices to compact devices with the size and appearance of myopic glasses. As AR glasses become lighter and smaller, the memory size and CPU computing power used in AR glasses will be affected to a certain extent, resulting in lag in the rendering and presentation of some complex scenes, or even failure to display.

In order to solve the problem that AR glasses themselves are unable to render complex scenes due to insufficient computing power, improve the picture rendering capabilities of AR glasses, and enhance user experience, an embodiment of the present application provides a method for controlling picture display of AR glasses, which uses a preconfigured rendering device to assist in completing the rendering task of AR glasses, and uses the AR glasses to display target display pictures rendered by each rendering device in a fusion manner, thereby avoiding the problem that AR glasses themselves are unable to render complex scenes due to insufficient computing power.

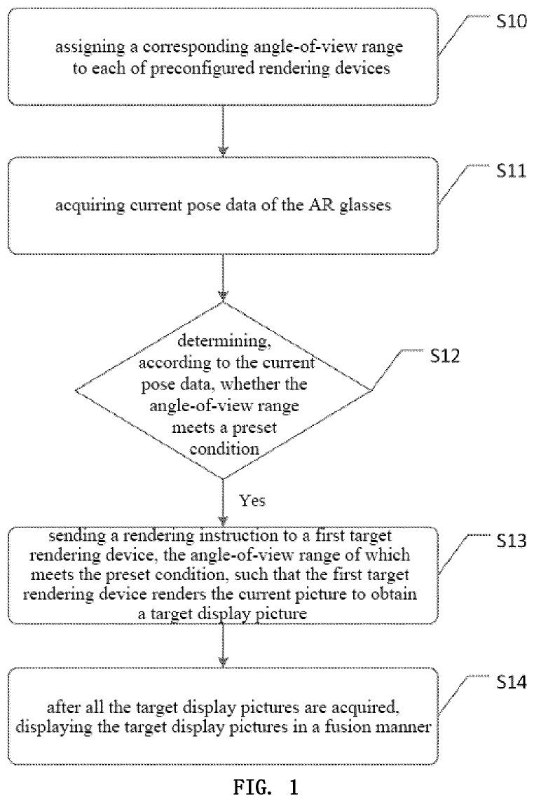

FIG. 1 is a flow chart of a method for controlling picture display of AR glasses provided in an embodiment of the present application. As shown in FIG. 1, the method includes:

S10: assigning a corresponding angle-of-view range to each of preconfigured rendering devices;

In a specific embodiment, when the AR glasses device is turned on, a 6DOF positioning and tracking system based on the AR glasses establishes a three-dimensional Euler coordinate system with the AR glasses as the origin. In addition, it is connected to a preconfigured rendering device through wireless streaming technology, and a corresponding angle-of-view range is assigned to each rendering device. It should be noted that the angle-of-view range is assigned based on the three-dimensional Euler coordinate system, which is configured to characterize the scene within the corresponding angle-of-view range rendered by the rendering device.

It can be understood that AR glasses themselves have a fixed field of view. When AR glasses move in three-dimensional space, when the field of view intersects with the angle-of-view range of the rendering device, the corresponding rendering device renders the scene picture within the angle-of-view range. Therefore, after establishing the three-dimensional Euler coordinate system, different rendering devices are pre-set to render scenes within different angle ranges, that is, different angle-of-view range is assigned to each rendering device.

It should be noted that the rendering device may be a mobile phone, tablet, notebook and other devices, and this application does not limit thereto. In addition, the number of devices selected is not limited in this application. Of course, it can be understood that when the scene to be rendered is a simple scene, for example, an image, and the AR glasses themselves can complete the rendering task, there is no need to use a rendering device for rendering. If a more complex scene is to be rendered, for example, when rendering a scene in a video, a rendering device for rendering is needed. At this time, the computing power of a rendering device is sufficient for rendering, and when the angle-of-view range is assigned to the device, the device is responsible for rendering scenes from multiple angles in three-dimensional space. When rendering complex scenes such as large-scale games, multiple rendering devices may be required for auxiliary rendering. When assigning angle-of-view ranges, different rendering devices are responsible for different angle-of-view ranges.

It should be noted that when multiple devices assist in rendering complex scenes, the angle-of-view range is assigned based on the computing power of the current device. That is, the device with stronger computing power is assigned a wider angle-of-view range, and conversely, the weaker the computing power, the narrower the assigned angle-of-view range.

S11: acquiring the current pose data of the AR glasses;

On the basis of establishing the three-dimensional Euler coordinate system in step S10, the current pose data of the AR glasses themselves are acquired in real time based on the three-dimensional Euler coordinate system. It can be understood that the pose data includes the current position information of the AR glasses, that is, the current coordinate data, and also includes posture information, that is, the current posture of the AR glasses at an angle.

S12: determining whether the angle-of-view range meets a preset condition according to the current pose data, if so, proceeding to step S13;

S13: sending a rendering instruction to a first target rendering device, the angle-of-view range of which meets the preset condition, such that the first target rendering device renders the current picture to obtain a target display picture;

S14: after acquiring each target display picture, displaying the target display pictures in a fusion manner.

According to the current pose data of the AR glasses themselves obtained in step S11, it is determined whether the angle-of-view range meets the preset condition. If the preset condition is met, a rendering instruction is sent to the first target rendering device whose angle-of-view range meets the preset condition. At this time, the first target rendering device renders the current picture to obtain the target display picture. It can be understood that according to the current pose data of the AR glasses themselves and the field of view of the AR glasses themselves, it can be determined whether the current AR glasses and the angle-of-view ranges of different rendering devices have an intersection. Therefore, the preset condition is specifically that the field of view of the AR glasses themselves intersects with the angle-of-view range of the rendering device.

When the AR glasses move and rotate in three-dimensional space, their own field of view will also move accordingly. When the field of view intersects with the angle-of-view range pre-assigned to different rendering devices, the rendering device having intersection is the first target rendering device. At this time, the first target rendering device renders the corresponding scene to obtain the target display picture.

It should be noted that the first target rendering device can be one or more. That is to say, during the movement and rotation of the AR glasses, the field of view may intersect with multiple angle-of-view ranges. At this time, there are multiple corresponding first target rendering devices. When rendering, the first target rendering device first determines a percentage of the intersection between the field of view of the AR glasses and the angle-of-view range of the first target rendering device against the angle-of-view range, and determines a ratio of the current picture rendered by the first target rendering device based on the percentage, and then renders according to the ratio.

After acquiring the target display picture rendered by each first target rendering device, it is determined whether the resolution of each target display picture reaches a preset value, and whether the number of target display pictures reaches a target number. In other words, when there are multiple first target rendering devices, it is determined whether the resolution of each rendered target display picture meets the requirements, and whether the same number of target display pictures as the first target rendering devices are obtained. When the number and resolution of the target display pictures meet the display condition, the target display pictures are displayed in a fusion manner.

When the field of view of the AR glasses has no intersection with the angle-of-view range of each rendering device, the wireless streaming connection between the AR glasses and each rendering device can be disconnected, so that the rendering device enters a sleep mode.

When the rendering device is performing a rendering task, if one or more devices are low on power or a device failure occurs and the rendering task is terminated, a target trigger instruction of the AR glasses will be triggered. At this time, the AR glasses will re-assign the angle-of-view range to the rendering device that is currently in a normal state based on the three-dimensional Euler coordinate system.

The method for controlling picture display of AR glasses provided in the embodiment of the present application includes: assigning a corresponding angle-of-view range to a preconfigured rendering device; acquiring the current pose data of the AR glasses themselves; according to the current pose data, determining whether the angle-of-view range meets a preset condition; if the angle-of-view range meets the preset condition, sending a rendering instruction to a first target rendering device, the angle-of-view range of which meets the preset condition, such that the first target rendering device renders the current picture to obtain a target display picture; and after all the target display pictures are acquired, displaying the target display pictures in a fusion manner. Thus, according to the technical solution of the present application, when the angle-of-view range corresponding to the preconfigured rendering device meets the preset condition, the rendering device completes a picture rendering job of AR glasses, and after all target display pictures rendered by a first target rendering device are obtained, the target display pictures are displayed in a fusion manner, such that the situation of picture lagging or it not being possible to complete rendering due to insufficient computing power when the AR glasses complete rendering by themselves is avoided, thereby improving the picture rendering capability and improving the user experience.

In a specific embodiment, when the field of view of the AR glasses intersects with the angle-of-view range of the rendering device, the rendering device corresponding to the angle-of-view range with the intersection is used as the first target rendering device. At this time, the first target rendering device renders the current picture to obtain the target display picture. For ease of understanding, an example will be given below.

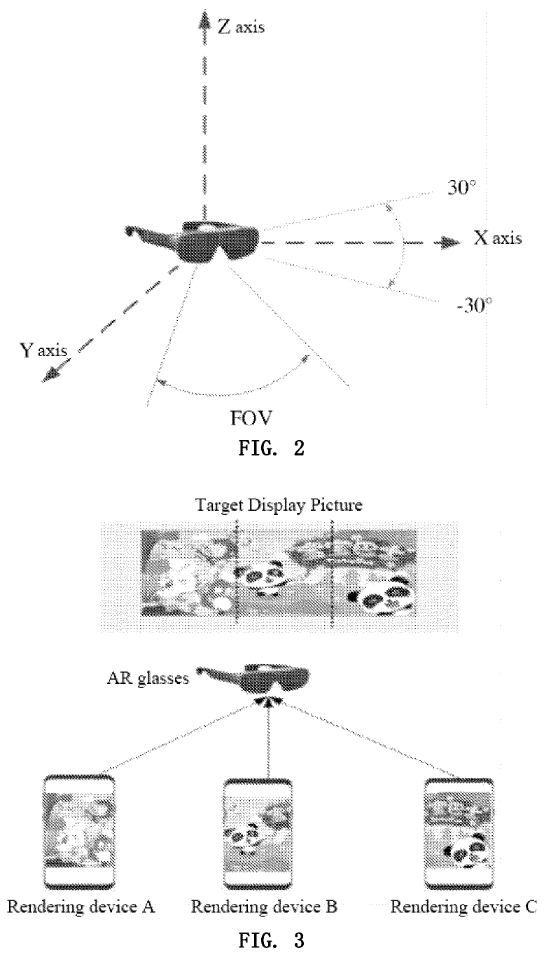

FIG. 2 is a schematic diagram of an angle-of-view range provided in an embodiment of the present application. As shown in FIG. 2, in the three-dimensional Euler coordinate system, the angle-of-view range View A assigned by the AR glasses to the rendering device A is −30° to 30° in a horizontal direction and −30° to 30° in a vertical direction, wherein the field of view of the AR glasses is FOV. When the user uses the AR glasses and moves the AR glasses in three-dimensional space, if the field of view of the AR glasses intersects with View A of the rendering device A, at this time, the AR glasses start a wireless streaming connection with the rendering device A, and the rendering device A performs rendering to obtain the target display picture and transmits it to the AR glasses for display.

The method for controlling picture display of AR glasses provided in the embodiment of the present application assigns a corresponding angle-of-view range in the three-dimensional space to each rendering device. When the field of view of the AR glasses intersects with the angle-of-view range of the rendering device, the corresponding rendering device renders the picture to obtain the target display picture. It can be seen that the rendering task of the AR glasses is completed with the assistance of the rendering device, thereby avoiding the insufficient computing power of the AR glasses unable to render complex scenes, and thus improving the user experience.

On the basis of the above embodiment, in order to save resources and ensure the use time of the rendering device after one full charge, when the AR glasses move in three-dimensional space and move to a point where the field of view and the angle-of-view range do not intersect each other, a sleep instruction is sent to the first target rendering device, so that the first target rendering device disconnects the wireless streaming connection with the AR glasses and enters the sleep mode to save power. Of course, the AR glasses continue to obtain their current pose data and determine in real time whether the field of view intersects with the angle-of-view range of the rendering device.

In fact, when users use AR glasses in certain scenarios, certain angles in the three-dimensional space do not need to be rendered. That is to say, if some angles in the three-dimensional space are not assigned to a certain device, if the field of view of the AR glasses enters the three-dimensional space angle at this time, that is, when the field of view of the AR glasses does not intersect with the angle-of-view range of the rendering device, the rendering device enters a sleep state to save power.

The method for controlling picture display of AR glasses provided in an embodiment of the present application sends a sleep instruction to the first target rendering device if it is determined that the field of view and the angle-of-view range do not intersect each other, so that the first target rendering device enters a sleep mode, thereby saving power and ensuring the length of time the rendering device can render the picture after being fully charged, and thus further improving the user experience.

It can be understood that when assigning the angle-of-view range of the rendering device, the angle-of-view range is related to the size of the rendered picture. FIG. 3 is a schematic diagram of an AR glasses picture rendering provided by an embodiment of the present application. For example, in FIG. 3, each rendering device renders one-third of the target display picture. Correspondingly, in the three-dimensional space, rendering device A, rendering device B, and rendering device C evenly distribute all angles in the three-dimensional space, that is, a sum of the angle-of-view range of each rendering device is the entire three-dimensional space.

At this time, when the AR glasses intersect with the angle-of-view range corresponding to any rendering device, a percentage of the intersection between the field of view of the AR glasses and the angle-of-view range against the angle-of-view rang is first determined, and then a ratio of rendering the current picture is determined based on the percentage. At this time, the rendering device renders the corresponding picture according to the ratio.

For example, in FIG. 3, the rendering device is responsible for rendering the leftmost picture in the target display picture, and the corresponding angle-of-view range is View A. When the field of view FOV of the AR glasses intersects with the angle-of-view range View A, and the intersecting part accounts for 50% of the angle-of-view range View A, the rendering device A renders half of the leftmost target display picture.

The method for controlling picture display of AR glasses provided in the embodiment of the present application first determines a percentage of the intersection between the field of view and the angle-of-view range against the angle-of-view range when rendering the current picture, and determines a ratio of rendering the current picture according to the percentage, and finally renders the current picture according to the ratio. Thus, the picture can be rendered according to the intersection of the current AR glasses and the angle-of-view range corresponding to the rendering device, avoiding rendering of some pictures that cannot be seen according to the field of view of the AR glasses, thereby improving the reliability of the AR glasses rendering picture.

On the basis of the above embodiment, after the first target rendering device renders the current picture to obtain the target display picture, the target display picture needs to be fused for display to the user. In order to improve the rendering accuracy, before fusion, it is necessary to first determine whether each target display picture meets the display condition, wherein the display condition is that the resolution of each target display picture reaches a preset value and the number of target display pictures reaches a threshold. If the display condition is met, the target display pictures can be fused and displayed.

When the display condition is not met, the resolution of the target display picture may not reach the preset value, indicating that the computing power of the current rendering device may be insufficient. In this case, it is necessary to reassign the area of the rendering picture that each rendering device is responsible for, that is, to reassign the angle-of-view range corresponding to each rendering device. After reassigning, it is necessary to re-acquire the current pose data of the AR glasses themselves in order to determine the current angle of the AR glasses in three-dimensional space so that the field of view intersects with the reassigned angle-of-view range, and then re-render the picture.

Of course, it is also possible that the number of target display pictures does not reach the target number. For example, there are 3 rendering devices for the rendering task, but the number of target display pictures obtained by the AR glasses is 2, which obviously does not meet the display condition. The rendering device that has not obtained the target display picture may fail or have an insufficient limit and fail to complete the rendering task. At this time, it is necessary to reassign the angle-of-view range to the rendering device. It can be understood that when the angle-of-view range is currently reassigned, it is only assigned to rendering devices that have not failed. In addition, the device information that has not been successfully rendered needs to be transmitted to the management end so that maintenance personnel can troubleshoot the problem in time.

It should be noted that the display condition may include but are not limited to the resolution of each target display picture reaching a preset value and the number of target display picture reaching a target number. This application does not limit the display condition.

The method for controlling picture display of AR glasses provided in the embodiment of the present application determines whether each target display picture meets the display condition before displaying the target display pictures in a fusion manner. If so, the target display pictures are displayed in a fusion manner. If not, the angle-of-view range is reassigned to the rendering device, and the current pose data is reacquired to determine the intersection of the current field of view and the reassigned angle-of-view range. In this way, the accuracy of the target display picture of the AR glasses is ensured, and the user experience is further improved.

In the above embodiment, when the target display picture does not meet the rendering condition, the angle-of-view range of the rendering device needs to be reassigned. In addition, when the AR glasses receive the target trigger instruction, the angle-of-view range also needs to be reassigned.

The target trigger instruction is an instruction generated when any rendering device is disconnected and/or the rendering task is terminated and/or the battery is insufficient, and the second target rendering device is a device that has not triggered the target trigger instruction. It should be noted that the condition for triggering the target trigger instruction may include but are not limited to the conditions mentioned above, and any factor that cannot complete the current rendering task can become a condition for triggering the target trigger instruction, which is not limited in this application.

It can be understood that when the rendering device is low on power or fails, it may not be able to complete the current rendering task. At this time, it is necessary to reassign the angle-of-view range for the second target rendering device, that is, to reassign the angle-of-view range for the rendering device that has not triggered the target trigger instruction. After reassigning the angle-of-view range, it is necessary to reacquire the current pose data of the AR glasses themselves in order to re-determine the intersection of the field of view and the reassigned angle-of-view range.

The method for controlling picture display of AR glasses provided in the embodiment of the present application triggers a target trigger instruction when any rendering device is disconnected and/or terminates the rendering task and/or is low on power, and after receiving the target trigger instruction, the corresponding angle-of-view range is reassigned to the second target rendering device, thereby avoiding rendering failures caused by failures of any rendering device and further improving the rendering success rate.

In a specific embodiment, in order to improve the rendering rate, when a corresponding angle-of-view range is assigned to a preconfigured rendering device, the performance parameters and the current application scenario of each rendering device are acquired; wherein the performance parameters include at least memory and computing power, and a target number of rendering devices is selected according to the current application scenario. It can be understood that different rendering scenarios require different numbers of rendering devices. In relatively simple rendering scenarios, fewer rendering devices are required, while in large-scale game rendering scenarios, more rendering devices are required. Therefore, it is needed to select a corresponding number of rendering devices according to the rendering scenario.

After determining the number of rendering devices, the performance of the target number of rendering devices is ranked, and angle-of-view ranges from large to small are assigned to corresponding rendering devices according to the performance from high to low. That is, for a rendering device with high performance, the assigned angle-of-view range can be relatively large, and vice versa, a smaller angle-of-view range is assigned to a rendering device with low performance.

The method for controlling picture display of AR glasses provided in an embodiment of the present application assigns a corresponding angle-of-view range to a preconfigured rendering device. The angle-of-view range is assigned according to the performance of each rendering device and the current application scenario. A rendering device with high performance renders more pictures, thereby improving the rendering rate of the picture.

In the above embodiments, the method for controlling picture display of AR glasses is described in detail, and the present application also provides an embodiment corresponding to a device for controlling picture display of AR glasses. It should be noted that the present application describes the embodiments of the device part from two perspectives, one is based on the perspective of the functional module, and the other is based on the perspective of the hardware structure.

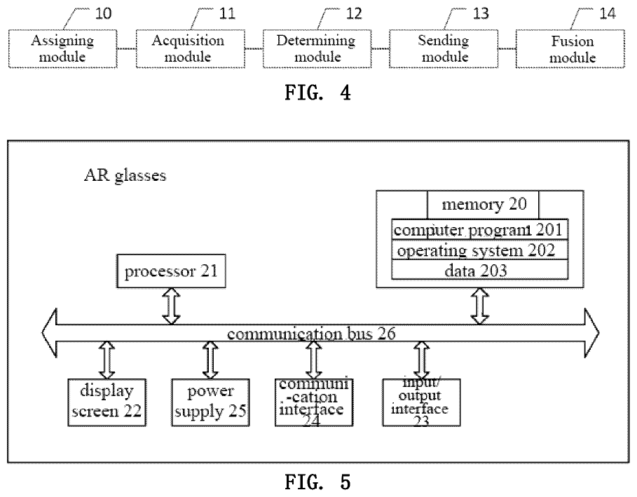

FIG. 4 is a structural diagram of a device for controlling picture display of AR glasses provided in an embodiment of the present application. As shown in FIG. 4, the device includes:
an assigning module 10 configured to assign a corresponding angle-of-view range to each of preconfigured rendering devices;
an acquisition module 11 configured to acquire current pose data of the AR glasses themselves;
a determining module 12 configured to determine whether the angle-of-view range meets a preset condition according to the current pose data, and if so, call a sending module 13;
the sending module 13 configured to send a rendering instruction to a first target rendering device, the angle-of-view range of which meets the preset condition, such that the first target rendering device renders the current picture to obtain a target display picture; and
a fusion module 14 configured to, after all the target display pictures are acquired, display the target display pictures in a fusion manner. Since the embodiments of the device part and the embodiments of the method part correspond to each other, the embodiments of the device part refer to the description of the embodiments of the method part, which will not be repeated here.

The device for controlling picture display of AR glasses provided in the embodiment of the present application includes: assigning a corresponding angle-of-view range to a preconfigured rendering device; acquiring the current pose data of the AR glasses themselves; according to the current pose data, determining whether the angle-of-view range meets a preset condition; if the angle-of-view range meets the preset condition, sending a rendering instruction to a first target rendering device, the angle-of-view range of which meets the preset condition, such that the first target rendering device renders the current picture to obtain a target display picture; and after all the target display pictures are acquired, displaying the target display pictures in a fusion manner. Thus, according to the technical solution of the present application, when the angle-of-view range corresponding to the preconfigured rendering device meets the preset condition, the rendering device completes a picture rendering job of AR glasses, and after all target display pictures rendered by a first target rendering device are obtained, the target display pictures are displayed in a fusion manner, such that the situation of picture lagging or it not being possible to complete rendering due to insufficient computing power when the AR glasses complete rendering by themselves is avoided, thereby improving the picture rendering capability and improving the user experience.

FIG. 5 is a structural diagram of AR glasses provided by another embodiment of the present application. As shown in FIG. 5, the AR glasses include:
a memory 20 on which a computer program is stored;
a processor 21 configured to implement steps of the method for controlling picture display of AR glasses as mentioned in the above embodiment when executing the computer program.

The processor 21 may include one or more processing cores, such as a 4-core processor, an 8-core processor, etc. The processor 21 can be implemented in at least one hardware form of a digital signal processor (referred to as DSP), a field-programmable gate array (referred to as FPGA), and a programmable logic array (referred to as PLA). The processor 21 may also include a main processor and a coprocessor. The main processor is a processor for processing data in an awake state, also known as a central processing unit (referred to as CPU); the coprocessor is a low-power processor for processing data in a standby state. In some embodiments, the processor 21 may be integrated with a graphics processing unit (referred to as GPU), and the GPU is responsible for rendering and drawing the content to be displayed on a display screen. In some embodiments, the processor 21 may also include an artificial intelligence (referred to as AI) processor, which is configured to process computing operations related to machine learning.

The memory 20 may include one or more computer-readable storage media, which may be non-transitory. The memory 20 may also include a high-speed random access memory, and a non-volatile memory, such as one or more disk storage devices, flash memory storage devices. In this embodiment, the memory 20 is at least configured to store the following computer program 201, wherein, after the computer program is loaded and executed by the processor 21, it can implement relevant steps of the method for controlling picture display of AR glasses disclosed in any of the aforementioned embodiments. In addition, the resources stored in the memory 20 may also include an operating system 202 and data 203, etc., and the storage method may be temporary storage or permanent storage. Among them, the operating system 202 may include Windows, Unix, Linux, etc. Data 203 may include, but is not limited to, relevant data involved in the method for controlling picture display of AR glasses.

In some embodiments, the AR glasses may also include a display screen 22, an input/output interface 23, a communication interface 24, a power supply 25, and a communication bus 26.

Those skilled in the art will appreciate that the structure shown in FIG. 5 does not constitute a limitation on the AR glasses and may include more or fewer components than shown.

The AR glasses provided in the embodiments of the present application include a memory and a processor. When the processor executes the program stored in the memory, it can implement the following method: the method for controlling picture display of AR glasses.

According to the AR glasses provided in the embodiments of the present application, when the angle-of-view range corresponding to the preconfigured rendering device meets the preset condition, the rendering device completes the picture rendering job of the AR glasses, and after acquiring the target display pictures rendered by the first target rendering device, the target display pictures are displayed in a fusion manner, thereby avoiding the situation of picture lagging or it not being possible to complete rendering due to insufficient computing power when the AR glasses themselves complete the rendering, thereby improving both the picture rendering capability and the user experience.

Finally, the present application also provides an embodiment corresponding to a computer-readable storage medium. The computer-readable storage medium stores a computer program, and when the computer program is executed by a processor, the steps recorded in the above method embodiment are implemented.

It can be understood that if the method in the above embodiment is implemented in the form of a software functional unit and sold or used as an independent product, it can be stored in a computer-readable storage medium. Based on this understanding, the technical solution of the present application is essentially or the part that contributes to the prior art or all or part of the technical solution can be embodied in the form of a software product, and the computer software product is stored in a storage medium to execute all or part of the steps of the method described in each embodiment of the present application. The aforementioned storage medium includes: U disk, mobile hard disk, read-only memory (ROM), random access memory (RAM), disk or optical disk and other media that can store program codes.

The above is a detailed introduction to a method for controlling picture display of AR glasses and its components provided by the present application. The various embodiments in the specification are described in a progressive manner, and each embodiment focuses on the differences from other embodiments. The same and similar parts between the embodiments can refer to each other. For the device disclosed in the embodiment, since it corresponds to the method disclosed in the embodiment, the description is relatively simple, and the relevant parts can refer to the method part description. It should be pointed out that for ordinary technicians in this technical field, without departing from the principles of the present application, several improvements and modifications can be made to the present application, and these improvements and modifications also fall within the scope of protection of the claims of the present application.

It should also be noted that, in this specification, relational terms such as first and second, etc. are only configured to distinguish one entity or operation from another entity or operation, and do not necessarily require or imply any such actual relationship or order between these entities or operations. Moreover, the terms “comprise”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the statement “comprises a . . . ” does not exclude the presence of other identical elements in the process, method, article or device including the element.

The serial numbers of the above-mentioned embodiments of the present application are for description only and do not represent the advantages or disadvantages of the embodiments.

In this specification, each embodiment is described in parallel or progressively, and each embodiment focuses on the differences from other embodiments. The same or similar parts between the embodiments can be referred to each other. For the device disclosed in the embodiment, since it corresponds to the method disclosed in the embodiment, the description is relatively simple, and the relevant parts can be referred to the method part description.

1. A method for controlling picture display of AR glasses, comprising:
assigning a corresponding angle-of-view range to each of preconfigured rendering devices;
acquiring current pose data of the AR glasses;
determining, according to the current pose data, whether the angle-of-view range meets a preset condition;
if the angle-of-view range meets the preset condition, sending a rendering instruction to a first target rendering device, the angle-of-view range of which meets the preset condition, such that the first target rendering device renders the current picture to obtain a target display picture; and
after all the target display pictures are acquired, displaying the target display pictures in a fusion manner.

2. The method for controlling picture display of AR glasses according to claim 1, wherein the determining, according to the current pose data, whether the angle-of-view range meets a preset condition comprises:
determining whether there is an intersection between the angle-of-view range and the field of view of the AR glasses according to the current pose data.

3. The method for controlling display of AR glasses according to claim 2, further comprising:
if it is determined that there is no intersection between the field of view and the angle-of-view range, sending a sleep instruction to the first target rendering device, and returning to the acquiring the current pose data of the AR glasses themselves.

4. The method for controlling picture display of AR glasses according to claim 2, wherein the rendering the current picture comprises:
determining a percentage of the intersection between the field of view and the angle-of-view range against the angle-of-view range;
determining a ratio of rendering the current picture according to the percentage; and
rendering the current picture according to the ratio.

5. The method for controlling display of AR glasses according to claim 2, further comprising: before the displaying the target display pictures in a fusion manner,
determining whether each of the target display pictures meets a display condition; wherein the display condition at least comprises that resolutions reach a preset value, and that a target number of the target display pictures are acquired;
if the display condition is met, proceeding to the displaying the target display pictures in a fusion manner;
if the display condition is not met, reassigning the angle-of-view range to the rendering devices, and proceeding to the acquiring the current pose data of the AR glasses themselves.

6. The method for controlling picture display of AR glasses according to claim 1, further comprising:
when a target trigger instruction is received, reassigning a corresponding angle-of-view range to a second target rendering device; wherein the target trigger instruction is an instruction generated when any one of the rendering devices is disconnected and/or the rendering task is terminated and/or the battery is low, and the second target rendering device is a device that has not triggered the target trigger instruction.

7. The method for controlling picture display of AR glasses according to claim 1, wherein the assigning a corresponding angle-of-view range to each of preconfigured rendering devices comprises:
acquiring performance parameters and current application scenarios of each of the rendering devices; wherein the performance parameters at least comprise memory size and computing power;
selecting a target number of rendering devices according to the current application scenario;
sorting the target number of rendering devices based on performances, and assigning angle-of-view ranges from large to small to corresponding rendering devices according to the performances from high to low.

8. A device for controlling picture display of AR glasses, comprising:
an assigning module configured to assign a corresponding angle-of-view range to each of preconfigured rendering devices;
an acquisition module configured to acquire current pose data of the AR glasses;
a determining module configured to determine whether the angle-of-view range meets a preset condition according to the current pose data, and if so, call a sending module;
the sending module configured to send a rendering instruction to a first target rendering device, the angle-of-view range of which meets the preset condition, such that the first target rendering device renders the current picture to obtain a target display picture; and
a fusion module configured to, after all the target display pictures are acquired, display the target display pictures in a fusion manner.

9. AR glasses, comprising:
a memory on which a computer program is stored; and
a processor configured to implement steps of the method for controlling picture display of AR glasses according to claim 1 when executing the computer program.

10. A non-transitory computer-readable storage medium, wherein a computer program is stored on the computer-readable storage medium, and when the computer program is executed by a processor, steps of the method for controlling picture display of AR glasses according to claim 1 are implemented.
